(19) United States
(12) Patent Application Publication
(10) Pub. No.: US 2005/0166689 A1
(43) Pub. Date: Aug. 4, 2005

(54) Mark provided in an environment to be measured and measuring system comprising same

(75) Inventors: Marc Viala, Varces (FR); Jean-Francois Larue, Voiron (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: ACTICM, Moirans (FR)

(21) Appl. No.: 10/509,577

(22) PCT Filed: Apr. 4, 2003
(86) PCT No.: PCT/FR03/01071

(30) Foreign Application Priority Data
Apr. 5, 2002 (FR) 02/04259

(51) Int. Cl. G08C 25/00; G08C 17/00; G08C 17/02; G01B 11/00; G01D 7/00

(52) U.S. Cl. 73/866.1; 340/870.28; 356/243.1

(57) ABSTRACT

A tag equipped with markers and, notably, optical markers that also include an electronic label that is adhered and that transmits the relative positions of the tags, or other characteristics of the tags, to a measuring system using telecommunication. Confusion between various tags can thus be avoided, and a greater interaction between the measuring system and the tag can be obtained.

This invention relates above all to a tag, herein called a tool, placed in an environment to be measured to provide a geometric reference, and also a system equipped with this tag.

In numerous three-dimensional measuring operations of an environment, tools are used that allow geometric references to be materialised into specific points of the measuring volume or of the object to be measured. These tools are generally fixed to equipment, such as mounting frames, or on the actual object to be measured. In some cases, in particular in the case of an optical measuring system, these tools can be mobile and handled by an operator or a robot in order to materialise the references into various points and thus perform the subsequent measurements.

Some tools include one or more metallic spheres whose position must be determined by tracing several points on each of the spheres when the technique used for performing the measurement is mechanical. Other tools include reflective prism targets when the equipment used includes a laser. Lastly, other tools include light points that are materialised either by retro-reflective targets, or by electroluminescent diodes when the technique used is photogrammetry. Several patents illustrating this type of tools or operating mode have been filed in previous years.

An example is found in Patent EP 0863 413 A1.

Generally, the tools therefore include several markers whose relative positions are used by matching them to their directions using the measurement method in order to obtain the position and direction of the entire tool.

The relative positions of the markers are obtained by previous gauging of the tool. These positions, which characterise each tool, are therefore generally recorded in a computer file. This design can cause errors because there are often several different tools, which can be confused. Furthermore, before each use of a new tool, the user must ensure that the file is loaded into the measuring system. Lastly, the user cannot query the characteristics of the object, measured using the tool without having to directly consult the computer that supervises the measuring system.

The tool according to the invention obviates these inconveniences; it is characterised in that it is equipped with an electronic label that includes a loaded memory of information describing the markers and the remote information communication means.

Other aspects of the invention will be described using the figures, in which:

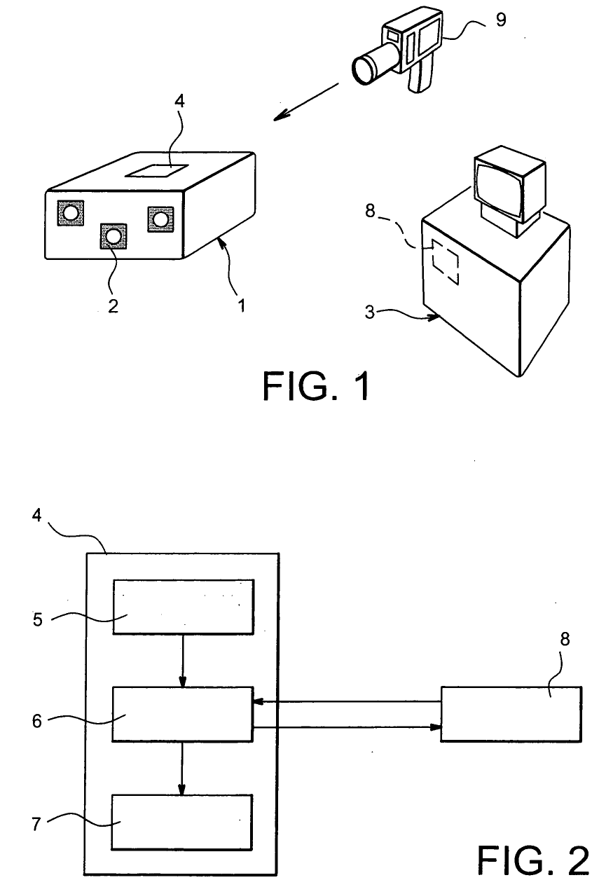

FIG. 1 is a general view of a measuring system, and

FIG. 2 illustrates the electronic label used and the communication means.

The device according to the invention allows its geometric parameters to be associated physically, and in a way that cannot be disassociated, to a tool 1 equipped with a plurality of markers 2, which, in this case, are optical in nature. The markers can be reflective or luminescent, specific or, in contrast, formed of larger light spots, and there is a sufficient number so as to draw a recognisable pattern. They can be similar to each other or, in contrast, different from each other. Connected to the tool 1 is an electronic label 4 that includes a memory 5 that makes it possible to record the description parameters of markers 2 and, notably, their geometric coordinates measured from a (any) source of the tool 1. The electronic label 4 also includes a transceiver 6 that can read the memory 5 content and transmit it to an analogue telecommunication means 8 connected to a computer 3 that supervises the measuring system by using the measurements from a camera 9, or from another device that can observe markers 2. Furthermore, the label 4 can be equipped with an LCD display 7 that directly shows the characteristics of the tool 1 without using the measuring system, and notably, without having to return to the computer 3. The additional information provided by the computer 3, and notably the operating modes or the measuring results, could also be displayed. The transmission can use infrared or radiophonic waves.

In this invention, the measurement starts by the computer 3 and the means 6 and 8 reading the contents of the memory 5 so that the correct characteristics of the tool 1 are employed.

The tool 1 thus becomes an element that is much more autonomous from the measuring system, which is of interest when it is to be handled by an operator, who can immediately verify the status or progress of the measurement. An example of such a situation arises when the tool 1 is a tracing point that moves along a structure whose shape is to be measured.

1-7. (canceled)

8: A tag placed in an environment to be measured, comprising:
reference markers;
an electronic label that includes a memory loaded with information describing the reference markers and a remote information communication mechanism.

9: A tag according to claim 8, wherein the information includes measurement position coordinates on the tag.

10: A tag according to claim 8, wherein the electronic label also includes an information display.

11: A tag according to claim 10, wherein the information display is an LCD display.

12: A tag according to claim 8, wherein the reference markers are either reflective or luminescent.

13: A tag according to claim 8, wherein the remote communication mechanism uses infrared or radiophonic waves.

14: An environment measuring system comprising:
at least one measuring device;
a measurement operation calculator;
a tag according to claim 8; and
remote communication resources that depend on the calculator and that are connected to the remote communication mechanism of the electronic label.
